(19) United States
(12) Patent Application Publication
(10) Pub. No.: US 2013/0162995 A1
(43) Pub. Date: Jun. 27, 2013

(54) Layer Thickness Measurement

(71) Applicants: Shuogang Huang, San Jose, CA (US); Chi-I Lang, Cupertino, CA (US); Jeffrey Chih-Hou Lowe, Cupertino, CA (US); Wen-Guang Yu, Zhubei City (TW)

(72) Inventors: Shuogang Huang, San Jose, CA (US); Chi-I Lang, Cupertino, CA (US); Jeffrey Chih-Hou Lowe, Cupertino, CA (US); Wen-Guang Yu, Zhubei City (TW)

(73) Assignee: Intermolecular, Inc., San Jose, CA (US)

(21) Appl. No.: 13/337,824

(22) Filed: Dec. 27, 2011

(51) Int. Cl. G01B 11/06; G01J 4/00

(52) U.S. Cl. 356/369

(57) ABSTRACT

A method of measuring the thickness of a one or more layers using ellipsometry is presented which overcomes problems with fitting a model to data collected in the presence of a top surface having a surface roughness (peak-to-trough) greater than about 100 Å. Prior to measurement, the top layer is pretreated to form an oxide layer of thickness between about 15 Å and about 30 Å. Ellipsometry data as a function of wavelength is then collected, and the ellipsometry data is fitted to a model including the oxide layer. For layers of doped polycrystalline silicon layers with a rough surface, the model comprises a layer consisting of a mixture of polycrystalline silicon and amorphous silicon and a top layer consisting of a mixture of polycrystalline silicon and silicon dioxide, and the pretreatment can be performed for about 10 minutes at 600 C in an oxygen atmosphere.

### FIELD OF THE INVENTION

One or more embodiments of the present invention relate to methods and apparatuses for measurement of layer thickness using ellipsometry and the like.

### BACKGROUND

The manufacture of semiconductor devices including integrated circuits, photovoltaic devices, and similar products often involves the deposition of precisely controlled layers of various materials. These layers may need to be carefully controlled in composition, crystalline structure, and thickness among other parameters. They are frequently very thin, although the thickness of individual layers can vary widely. In most cases, the layers are deposited on very smooth substrates and each successive interface between layers is similarly smooth. However, certain processes can produce rough surfaces. For example, one way of doping a silicon layer to form a doped-silicon semiconductor layer is to first form a pure silicon layer (which may be amorphous or polycrystalline) and then inject the dopants into the layer as high-energy ions. While an effective means of precise composition control, the method tends to roughen the surface by a sputtering mechanism where silicon atoms are driven from the surface. Subsequent etching steps can also create or increase surface roughness.

Measurement of the thicknesses of a structure comprising multiple layers is frequently required, both for process development research activities and for manufacturing process control. The individual layer thickness is often less than the wavelength of visible light, and special measurement techniques are required. Both destructive and non-destructive techniques are known. A commonly used destructive technique is to cut a sample in half and make measurements by looking edge-on at the layers using a scanning electron microscope. While this can be an accurate method that is unaffected by surface roughness (or even allows the measurement of surface roughness), there is frequently a need for a non-destructive measurement.

A commonly used tool for non-destructive layer thickness measurement is ellipsometry. Ellipsometry is an optical technique for the measurement of the dielectric properties (complex refractive index or dielectric function) of thin layers. Polarized light is reflected from a surface, and changes in polarization are measured. Ellipsometry is commonly used to characterize layer thickness for single layers or complex multilayer stacks ranging from a few angstroms to several microns with excellent accuracy. Data are typically collected as a function of the wavelength of the incident light. The reflection signal from a multilayer stack is complicated by the multiple reflections that can occur from the various layer interfaces. However, it is straightforward to model these multiple reflections theoretically, based, for example, on the known composition of each layer with the layer thicknesses taken as unknowns. Such models are typically included with the software that accompanies commercial ellipsometry instruments such as the ellipsometer from J.A. Woolam Co. used in the Examples herein. The unknown parameters (layer thicknesses in this example) can be determined by a least squares fit to the experimental data.

The quality of the fit and the resulting measurement error for fitted thicknesses is dependent on the accuracy of the model relative to the physical sample to be measured. The standard models assume smooth surfaces, and rough surfaces can result in poor quality fits and large thickness errors.

### SUMMARY OF THE INVENTION

A method of measuring the thickness of a one or more layers using ellipsometry is presented which overcomes problems with fitting a model to data collected in the presence of a top surface having a surface roughness (peak-to-trough) greater than about 100 Å. Prior to measurement, the top layer is pretreated to form an oxide layer of thickness between about 15 Å and about 30 Å. The pretreatment can be performed at elevated temperature. Ellipsometry data as a function of wavelength is then collected, and the ellipsometry data is fitted to a model including the oxide layer.

In some embodiments, at least one layer comprises a semiconducting material. For the example of doped polycrystalline silicon layers with a rough surface, the model comprises a layer consisting of a mixture of polycrystalline silicon and amorphous silicon and a top layer consisting of a mixture of polycrystalline silicon and silicon dioxide, and the pretreatment can be performed for about 10 minutes at 600 C in an oxygen atmosphere.

### BRIEF DESCRIPTION OF THE DRAWINGS

FIG. 1 shows atomic force microscope measurement of the surface roughness of a doped polycrystalline silicon thin layer.

FIG. 2 shows examples of ellipsometry data for rough-surface doped polycrystalline silicon thin layers with and without a pretreatment to form a surface oxide layer.

FIG. 3 shows examples of thickness measurement after etching for variable time at various temperatures using a measurement method provided by an embodiment of the present invention.

FIG. 4 shows the thickness removed when the surface oxide layer is stripped.

### DETAILED DESCRIPTION

Before the present invention is described in detail, it is to be understood that unless otherwise indicated this invention is not limited to specific layer compositions. Exemplary embodiments will be described for the measurement of doped polycrystalline silicon layers having a rough surface, but measurements of any layers that can be measured by ellipsometry or other methods involving the fit of a theoretical model to indirect data may benefit from the improved signal-to-noise achieved using the methods disclosed herein. Doped silicon is exemplary of a semiconducting material that can benefit from the methods of the present invention, but any semiconducting material can be used such as those based on silicon, germanium, selenium, silicon carbide, silicon germanium, aluminum antimonide, aluminum arsenide, aluminum nitride, aluminum phosphide, boron nitride, boron phosphide, boron arsenide, gallium arsenide, gallium phosphide, gallium antimonide, indium arsenide, indium phosphide, and indium antimonide, and the like, so long as an oxide, nitride or oxynitride layer can be formed on the semiconducting material at the surface. It is also to be understood that the terminology used herein is for the purpose of describing particular embodiments only and is not intended to limit the scope of the present invention.

It must be noted that as used herein and in the claims, the singular forms “a,” “and” and “the” include plural referents unless the context clearly dictates otherwise. Thus, for example, reference to “a layer” includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. Where the modifier “about” is used, the stated quantity can vary by up to 10%.

### Definitions

As used herein, the term “annealing” refers to a heat treatment wherein a material is heated to an elevated temperature, held at a suitable temperature for a period of time, and then cooled, typically slowly to prevent any thermal shock during cooling. For semiconductors, annealing is commonly used to relieve strain built up during process steps as well as to allow some limited atomic migration. The crystalline structure of the material can also be altered, for example to convert amorphous silicon to polycrystalline silicon, although frequently, annealing is done under conditions where no change in crystalline structure takes place.

As used herein, the term “substantially no change in crystalline structure” refers to the condition where the ratio of amorphous to polycrystalline material remains the same to within 5%.

As used herein, the term “surface roughness” refers to the maximum peak-to-trough deviation in the dimension normal to the surface.

As used herein, the term “top surface” refers to the one surface that exists on the top-most surface of a material comprising one or more layers. Where the layers are formed on a substrate, the top surface is the surface that is furthest from the substrate.

As used herein, the term “ellipsometry” refers to a method of analyzing a structure comprising a plurality of material layers by illuminating a surface with polarized light. The light is variously transmitted through and reflected by the material layers. The net reflected light is filtered by an additional polarizer, and light of both polarities is detected. Typically, data are collected and plotted for both polarities as a function of wavelength from about 400 nm to about 1000 nm. A theoretical “ellipsometry model” corresponding to the structure under test is built (see below). The model includes a set of unknown parameters (layer thicknesses and relative material compositions). The unknown parameters can be estimated by fitting a theoretical curve derived from the model to the data. If the net fitting error is low enough, the model is said to “fit” the data, and the model is “confirmed” in the sense that the data support a conclusion that the model correctly corresponds to the physical structure under test. The fitting parameters can then be considered relevant to the physical structure and said to be a “measurement” of the true physical value of that parameter.

As used herein, the term “ellipsometry model” refers to a theoretical construct used to model the structure of a particular set of layers under test. A typical ellipsometry model comprises a plurality of layers of varying thickness and composition. It is possible to model individual layers as comprised of a single material or a plurality of materials. A stored library of material properties provides information as to how light interacts with each type of material. The model is typically specified with a set of fitting parameters, although certain values can be fixed if they are known or unimportant. Common fitting parameters comprise one or more layer thicknesses or one or more relative compositions for a layer having mixed composition.

Many processes for the manufacture of integrated circuits, display devices, and photovoltaic devices among others require the step of formation of thin layers of various materials including insulators, conductors, and semiconductors. It is often necessary to measure the thickness of layers, both for analysis of layers already made and to assist in process control during layer deposition. Ellipsometry is commonly used to measure layer thicknesses. A particular measurement difficulty can be caused by the presence of doped semiconductor layers that exhibit significant surface roughness. Such roughness can occur, for example, as a byproduct of ion implantation used to add dopants to a layer. Ellipsometry models usually assume smooth parallel surfaces, and very poor fits to experimental data are observed for rough surfaces. Thus, there is a need for an improved approach to non-destructive thickness measurement that can accommodate rough surfaces and still provide good measurement accuracy.

According to one or more embodiments of the present invention, methods of measuring the thickness of one or more layers using ellipsometry is provided. The method comprises providing a substrate having one or more layers deposited thereon, wherein the top surface has a surface roughness (peak-to-trough) greater than about 100 Å. A pretreatment (before ellipsometry is performed) is used to compensate for the surface roughness. A thin oxide, nitride, or oxynitride layer is formed having a thickness between about 15 Å and about 30 Å by exposing the top surface to oxygen, nitrogen, or a combination thereof. Ellipsometry data is collected as a function of wavelength, and the ellipsometry data are fitted to a model including the oxide, nitride, or oxynitride layer. The methods allow a standard theoretical multilayer ellipsometry model to be used from which reliable thickness measurements can be inferred.

The pretreatment can be implemented at a variety of temperatures. At some elevated temperatures certain material changes may occur which are generally described as “annealing” effects (stress relief, atomic migration, or recrystallization, for example). Depending on the material layers to be measured, such annealing may already have been performed, may be planned as a subsequent process step, or may be undesirable. If the annealing process is not undesirable, then the pretreatment can be performed at any convenient temperature. If the annealing process is undesirable, then it can be preferable to use a pretreatment temperature below that at which the undesired effect takes place. As described in detail in the examples below, a satisfactory pretreatment temperature and time can be found for at least certain layer materials such that no annealing effect occurs.

Any convenient heating method can be used if heating is a desired aspect of the pretreatment. For example, a lamp-based Rapid Thermal Processing (RTP) system can be used for the pretreatment. The system has banks of linear tungsten halogen lamps and illuminates a sample wafer from both top and bottom through a quartz process tube to rapidly heat the sample. Wafer temperatures are measured using a pyrometer. A typical RTP annealing process for silicon wafers heats the wafers above the annealing temperature (at least 1000 C and up to 1,200 C or greater) for a few seconds. The same equipment can be used for longer pretreatment times at lower temperatures.

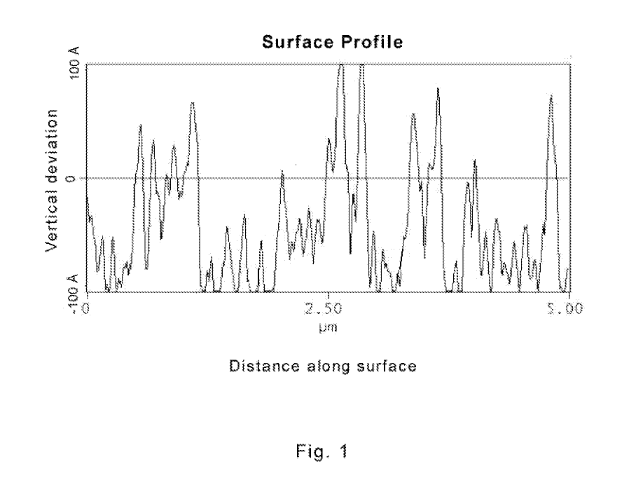

As discussed in Example 1, samples of doped polycrystalline silicon were measured using an atomic force microscope, and a typical profile across a 5 μm line on the surface is shown in FIG. 1. The peak-to-trough roughness can be seen to be ˜200 Å. Such samples show a poor fit to models when using ellipsometry to measure the thickness of layers that are present.

As discussed in Example 2, 2800 Å thick samples of doped polycrystalline silicon were treated to form a surface oxide layer by exposing the samples to an oxygen atmosphere for 10 min at 600 C using a RTP system. The result was the formation of a ˜21 Å thick layer of SiO₂. Treatment at 600 C is at a temperature well below that at which annealing effects occur in amorphous or polycrystalline silicon. The SiO₂ can be easily stripped using dilute HF, if necessary, for subsequent operations or processing steps.

The pretreatment dramatically improved the quality of the fit of a theoretical model to experimental ellipsometry spectra. Without the sample pretreatment, the fit of the ellipsometry data to the theoretical multilayer ellipsometry model can be poor if there is significant surface roughness; with the sample pretreatment, the fit can be dramatically improved, and the resultant thickness measurements can be validated. These results can be seen in detail in the examples below. As shown in Example 2, an untreated sample showed a mean square error (MSE) value of 532 (See Table 1). In contrast, the pretreated sample showed a MSE value of only 34, consistent with a good fit of the model to the experimental ellipsometry data.

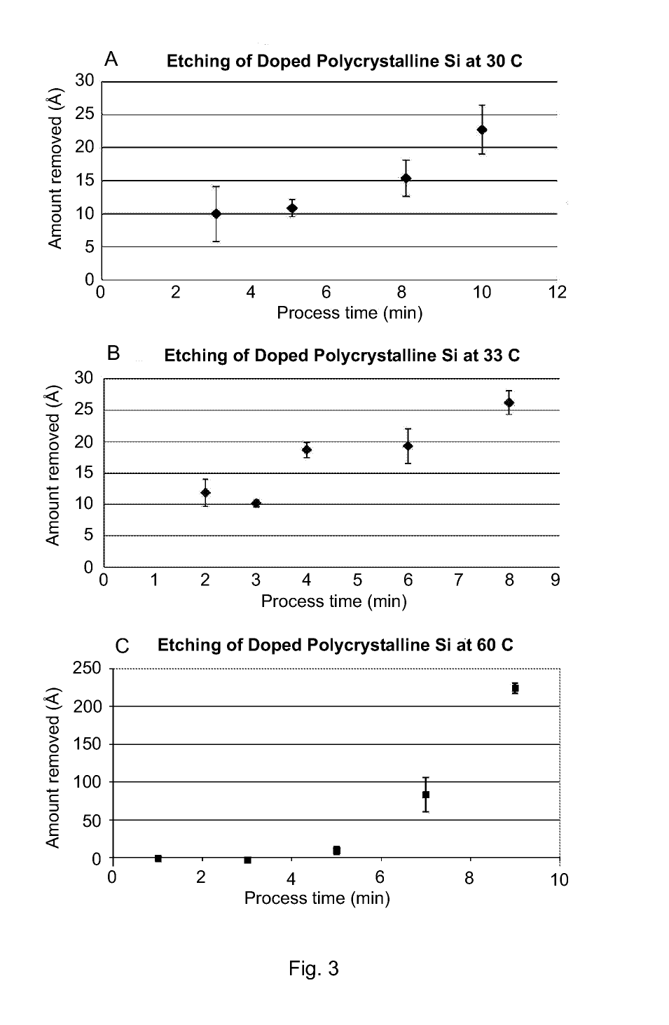

The pretreatment methods disclosed herein can be usefully applied in semiconducting materials processing steps. As shown in Example 3, the pretreatment method was used to show the efficacy of various etching conditions, and demonstrated that the etching of the doped polycrystalline silicon could be controlled by temperature and time (FIGS. 3A-C).

While pretreatment to form an oxide is a preferred embodiment, similar results can also be achieved by pretreatment in nitrogen or oxygen/nitrogen atmospheres to form nitrides or oxynitrides. In general, the oxide layer can be formed with a lower temperature pretreatment, and is therefore less likely to risk annealing effects. However, for measurements on materials that have been or will be annealed anyway, annealing effects may not be undesirable, and nitrogen with or without oxygen can be used for the pretreatment.

Various time/temperature combinations can be used to achieve the desired effect. For the example of a doped polycrystalline silicon layer, 600 C for 10 min was found to provide a preferred minimum time and temperature to achieve the desired effect. One of ordinary skill can readily ascertain useful pretreatment conditions for layers of other semiconducting materials. Pretreatment with nitrogen similarly requires higher temperatures, such as 950 C and variable times for different semiconducting materials. Alternatively, a plasma of nitrogen or nitrogen and oxygen can be utilized to generate the nitride or oxynitride layer, and can be performed at lower temperatures than when using thermal methods.

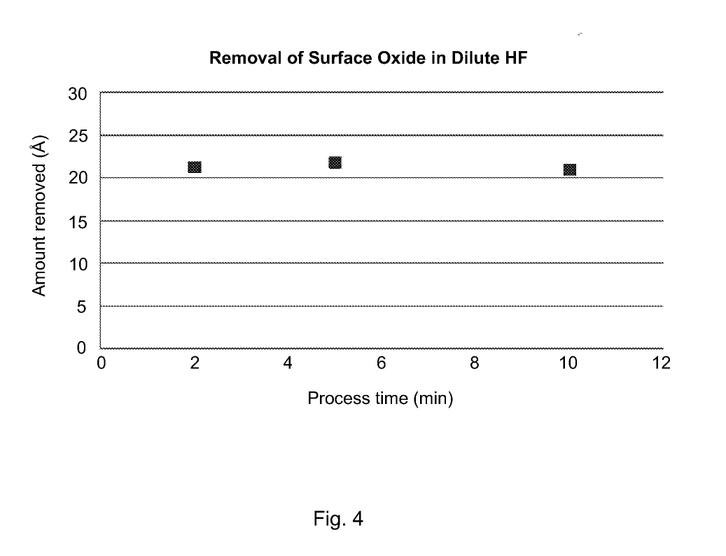

As mentioned above, the SiO₂ can be easily stripped using dilute HF, if necessary, for subsequent operations or processing steps. Stripping of the SiO₂ is demonstrated in Example 4, where the pretreated doped polycrystalline silicon was treated with dilute HF for times varying from 2 to 10 minutes. As shown in FIG. 4, there is no additional amount removed over time, indicating that the removal of SiO₂ is very rapid.

Various theories can be proposed to explain the improved fit of the theoretical model to experimental ellipsometry data from rough-surfaced samples. For example, the optical properties of SiO₂ and polycrystalline silicon are quite different. Bulk SiO₂ is much more transparent through the visible spectrum and has a very different index of refraction from that of bulk Si. The different grain orientations and grain boundaries in polycrystalline silicon tend to introduce noise in reflected polarized light. The relative importance of the reflection from different surface boundaries, and the importance of particular noise effects can be changed by changing the thickness of the surface oxide (or nitride). While it may be difficult to model these various effects in detail and in combination, the experimental observation is that the increased surface oxide layer thickness provides sufficient improvement in the fit of a model based on smooth surfaces to ellipsometry data for samples including a rough surface that reliable thickness measurements can be obtained.

### EXAMPLES

### Example 1

### Surface Roughness Measurement

Profiles of samples of doped polycrystalline silicon were measured using a Nanoscope Atomic Force Microscope (Bruker AXS, Madison, Wis.). A typical profile across a 5 μm line on the surface is shown in FIG. 1. The peak-to-trough roughness can be seen to be ˜200 Å.

### Example 2

### Ellipsometry Measurements With and Without Surface Pretreatment

Doped polycrystalline silicon samples were provided comprising an unknown thickness of doped polycrystalline silicon on ˜4000 Å of SiO₂ on a silicon wafer. The surface roughness of the samples was comparable to that measured in Example 1. The samples were analyzed on an M-2000D ellipsometer (J.A. Woollam Co., Lincoln, Nebr.) and analyzed using the WVASE32 data acquisition and analysis software provided by Woollam.

Doping is generally found to increase the amount of amorphous silicon present in a polycrystalline layer. Therefore, an ellipsometry model for fitting compositional parameters was proposed: the model comprising four layers: (0) a base layer of 1 mm Si (which is equivalent to bulk Si), (1) a layer of SiO₂ of unknown thickness, (2) a layer comprising a mixture of polycrystalline Si and amorphous Si of unknown thickness and unknown relative composition, and (3) a layer comprising polycrystalline Si and SiO₂ of unknown thickness and unknown relative composition. These last two layers are represented by an “effective medium approximation,” where the specified mixture is used to approximate the actual composition and structure. The model for layer 2 includes both polycrystalline and amorphous silicon to account for the presence of some amorphous silicon mixed with the doped polycrystalline silicon. (The dopants are not present in sufficient concentration to affect the optical properties of the layer directly.) The model for layer 3 includes both Si and SiO₂, because the surface roughness is larger than the SiO₂ layer thickness. Note that the fitted thickness for the model layer 3 falls between the measured roughness (Example 1) and the oxide thickness (Example 4).

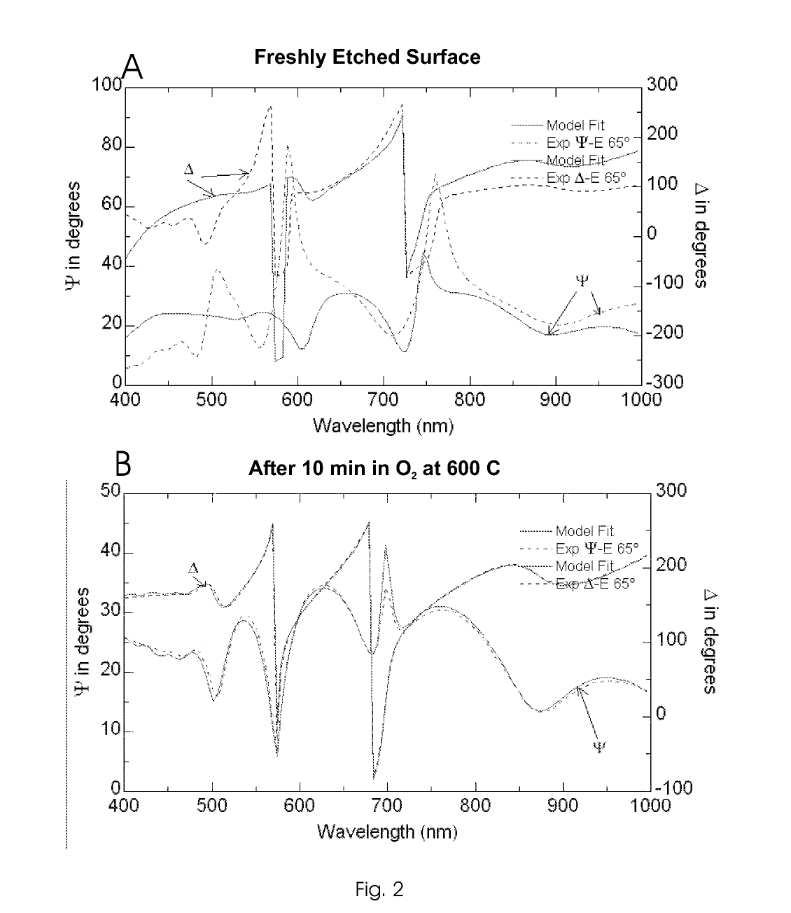

A total of five fitting parameters were thus available, three thicknesses (thickness 1-3 in Table 1) and two relative composition parameters (the relative percentage parameters for layer 2 and 3 in Table 1). FIG. 2 shows graphs of the ellipsometry data and best fits to the theoretical model before (A) and after (B) a pretreatment of 10 min at 600 C in a 100% oxygen atmosphere. The dotted lines are experimental ellipsometry data collected over a wavelength range of 400 to 1000 nm. The incident angle of the light beam is 65°. The measured values are expressed as Ψ and Δ, which are related to the ratio of Fresnel reflection coefficients for p- and s-polarized light. The solid lines show the best fit model, for both Ψ and Δ. The software algorithm finds the best fit between the experimental data and the model by varying the fitting parameters (layer thicknesses and layer compositions).

The fitting results are summarized in Table 1.

TABLE 1

| Fit parameter | untreated sample | pretreated sample |
|---|---|---|
| thickness 3 | 352.17 ± 28.50 Å | 38.82 ± 3.24 Å |
| thickness 2 | 2735.62 ± 95.60 Å | 2815.70 ± 5.53 Å |
| thickness 1 | 4050 ± 290 Å | 3990.75 ± 9.22 Å |
| layer 2% a-Si | 83% ± 21 | 20.60% ± 0.53 |
| layer 3% SiO₂ | 58.13% ± 4.75 | 38.83% ± 3.24 |
| mean square error (MSE) | 532 | 34.43 |

As can be seen from the Table 1, the overall fitting error (MSE) decreased dramatically with the pretreatment corresponding to the qualitatively better fit that can be seen in the graph of FIG. 2B compared to that of FIG. 2A. It is also generally accepted that when the overall fitting error is greater than about 40, the model should be improved and the fitted data should not be considered reliable. Thus, the thicknesses derived from measurements of the untreated sample data would be considered unusable, because the data failed to confirm and validate the chosen model, while thicknesses derived from measurements of the pretreated samples are usable.

The compositional fitting parameters are considered arbitrary, and no special significance is assigned to the values as fitted. Similarly, since thickness 3 is used to model a layer with a large surface roughness, no special significance is given to its fitted value. The only number that is taken to correspond to physical reality is the sum of thickness 2 and thickness 3 which is taken to be a measure of the original doped polycrystalline silicon layer (2854.5 Å in this example). While there may still be some uncertainty of the order of the surface roughness in the absolute value of thickness, differential measurements such as those described in Examples 3 and 4 are unaffected, because this error is subtracted out.

### Example 3

### Use of Measurement Method

Three series of samples were prepared and measured according to the method of Example 2. Each sample was measured before and after etching for a particular process time using an etchant comprising HNO₃ and HF. In the first series the etchant temperature was 30 C; in the second series, the etchant temperature was 33 C; in the third series, the etchant temperature was 60 C. All samples were treated at 600 C in a pure oxygen atmosphere for 10 min prior to ellipsometry measurement, both before and again after the etching process. The results are shown in FIG. 3A-C. The error bars represent experimental scatter (standard deviation) from ten measurements at different locations on the same samples. The results show good measurement repeatability and the expected trends as a function of process time and temperature. In all cases, the etching was slow for the first five minutes or so, and then increased more rapidly thereafter. The rate of increase was larger at higher temperature.

### Example 4

### Thickness of Oxide Layer Created by Pretreatment

Three samples were prepared and measured after pretreatment as described in Example 2. The samples were then immersed in dilute (100:1 by volume) HF for varying treatment times, then rinsed with water and dried. Each sample was again pretreated in a pure oxygen atmosphere for 10 min at 600 C and then measured using ellipsometry as described in Example 2. The thickness loss as a function of treatment time is shown in FIG. 4. All samples showed approximately the same thickness loss (˜21 Å) indicating (1) that the surface oxide layer was completely removed during the first two minutes of treatment with dilute HF, and (2) that the surface oxide layer formed by the oxygen pretreatment of 10 min at 600 C was ˜21 Å thick. Since the spacing of Si atoms in SiO₂ is about 3 Å, this indicates oxidation of about 7 layers of Si atoms. In contrast, the native oxide formed by exposure of the polycrystalline silicon surface to air at room temperature is typically only one or two Si atom layers thick for short term exposure and about four layers thick after several days. The pretreatment at elevated temperature in pure oxygen causes oxygen to diffuse faster and deeper through the growing oxide layer to the underlying silicon, allowing a thicker layer to be rapidly produced.

It will be understood that the descriptions of one or more embodiments of the present invention do not limit the various alternative, modified and equivalent embodiments which may be included within the spirit and scope of the present invention as defined by the appended claims. Furthermore, in the detailed description above, numerous specific details are set forth to provide an understanding of various embodiments of the present invention. However, one or more embodiments of the present invention may be practiced without these specific details. In other instances, well known methods, procedures, and components have not been described in detail so as not to unnecessarily obscure aspects of the present embodiments.

What is claimed is:

1. A method of measuring the thickness of one or more layers using ellipsometry comprising
providing a substrate having one or more layers deposited thereon, wherein a top surface of the one or more layers on the substrate has a surface roughness (peak-to-trough) greater than about 100 Å,
forming one of an oxide, nitride, or oxynitride layer having a thickness between about 15 Å and about 30 Å by exposing the top surface of the one or more layers to a gas comprising oxygen, nitrogen, or a combination thereof,
collecting ellipsometry data of the one or more layers as a function of wavelength, and
fitting the ellipsometry data to a model of the one or more layers including the oxide, nitride, or oxynitride layer.

2. The method of claim 1, wherein a top layer comprises a semiconducting material.

3. The method of claim 2, wherein the semiconducting material comprises Si, Ge, SiGe, GaAs, or InP.

4. The method of claim 2, wherein the top layer comprises doped silicon.

5. The method of claim 4, wherein the model comprises a layer consisting of a mixture of polycrystalline silicon and amorphous silicon and a layer consisting of a mixture of polycrystalline silicon and silicon dioxide.

6. The method of claim 4, wherein the model comprises a layer consisting of a mixture of polycrystalline silicon and amorphous silicon and a surface layer consisting of a mixture of polycrystalline silicon, and silicon nitride.

7. The method of claim 4, wherein the model comprises a layer consisting of a mixture of polycrystalline silicon and amorphous silicon and a surface layer consisting of a mixture of polycrystalline silicon, silicon dioxide, and silicon nitride.

8. The method of claim 4, wherein the forming is for a time and at a temperature such that substantially no change in crystalline structure occurs in the doped silicon.

9. The method of claim 4, wherein the forming is at a temperature of about 600 C, and the exposing is to oxygen for about 10 minutes.

10. The method of claim 1, wherein the forming is at a temperature of about 950 C and the exposing is to nitrogen for about 1 minute.

11. The method of claim 1, wherein the exposing is to a nitrogen plasma.

12. The method of claim 1, wherein the exposing is to an oxygen plasma.

13. The method of claim 1, wherein the exposing is to a plasma formed using oxygen and nitrogen.

14. The method of claim 1, wherein the one or more layers comprise at least two layers of a semiconducting material and the top two layers comprise a layer of doped silicon and a layer of silicon dioxide, wherein the silicon dioxide layer is on the top and has a thickness less than about 12 Å.

15. The method of claim 14, wherein the model comprises a layer consisting of a mixture of polycrystalline silicon and amorphous silicon and a surface layer consisting of mixture of polycrystalline silicon and silicon dioxide.

16. The method of claim 14, wherein the forming is for a time and at a temperature such that substantially no change in crystalline structure occurs in the doped silicon.

17. The method of claim 14, wherein the forming is at a temperature of about 600 C, and the exposing is to oxygen for about 10 minutes.

18. A method of measuring the thickness of one or more layers using ellipsometry comprising
providing a substrate having one or more layers deposited thereon, wherein a top surface of the one or more layers on the substrate has a surface roughness (peak-to-trough) greater than about 100 Å;
forming an oxide layer having a thickness between about 15 Å and about 30 Å by exposing the top surface of the one or more layers to oxygen at an elevated temperature;
collecting ellipsometry data of the one or more layers as a function of wavelength; and
fitting the ellipsometry data to a model of the one or more layers including the oxide layer;
wherein the top layer comprises a semiconducting material selected from the group consisting of Si, Ge, SiGe, GaAs, and InP.

19. A method of measuring the thickness of one or more layers using ellipsometry comprising
providing a substrate having one or more layers deposited thereon, wherein a top surface of the one or more layers on the substrate has a surface roughness (peak-to-trough) greater than about 100 Å;
forming a nitride layer having a thickness between about 15 Å and about 30 Å by exposing the top surface of the one or more layers to a plasma formed from nitrogen;
collecting ellipsometry data of the one or more layers as a function of wavelength; and
fitting the ellipsometry data to a model of the one or more layers including the nitride layer;
wherein the top layer comprises a semiconducting material selected from the group consisting of Si, Ge, SiGe, GaAs, and InP.
